(19) United States
(12) Patent Application Publication
(10) Pub. No.: US 2016/0119698 A1
(43) Pub. Date: Apr. 28, 2016

(54) LOUDSPEAKER

(71) Applicant: HON HAI PRECISION INDUSTRY CO., LTD., New Taipei (TW)

(72) Inventor: KUO-HSIANG OU YANG, New Taipei (TW)

(21) Appl. No.: 14/527,436

(22) Filed: Oct. 29, 2014

(30) Foreign Application Priority Data
Oct. 23, 2014 (TW) 103136559

(51) Int. Cl. H04R 1/02

(52) U.S. Cl. CPC H04R 1/02

(57) ABSTRACT

Loudspeaker includes a voice coil, a protecting cover attached to the voice coil, a washer, and a voice cavity case. The voice cavity top case includes a top panel and a resisting panel coupled to the top panel. The revisiting panel is sandwiched between the washer and the voice coil. A top surface of the top panel is aligned with a top surface of the protecting cover.

### FIELD

The subject matter herein generally relates to a loudspeaker.

### BACKGROUND

Known loudspeakers typically comprise a driver and an enclosure. The components of the driver typically include a magnet (or more specifically, a magnet with a top plate and yoke), a voice coil, a sound radiating element (typically, a cone), suspensions, and a basket or frame. The cone may also be referred to as a radiator or diaphragm.

The voice coil is rigidly attached to the cone, and the magnet is stationary, attached to the enclosure of the loudspeaker. The voice coil and magnet are arranged such that the voice coil is placed in the magnetic field of the magnet. In operation, current flows through the voice coil, which when placed in this magnetic field, causes the voice coil to move in response to an applied signal. As the voice coil and cone move as one entity, movement of the voice coil results in movement of the cone to radiate sound.

### BRIEF DESCRIPTION OF THE DRAWINGS

Implementations of the present technology will now be described, by way of example only, with reference to the attached figures.

FIG. 1 is an exploded, isometric view of an embodiment of a loudspeaker.

FIG. 2 is an assembled view of the loudspeaker of FIG. 1.

FIG. 3 is a cross-sectional view of FIG. 2, taken along a line III-III.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a loudspeaker comprising a voice coil, a protecting cover attached to the voice coil, a washer, and a voice cavity case. The voice cavity top case is aligned with the protecting cover.

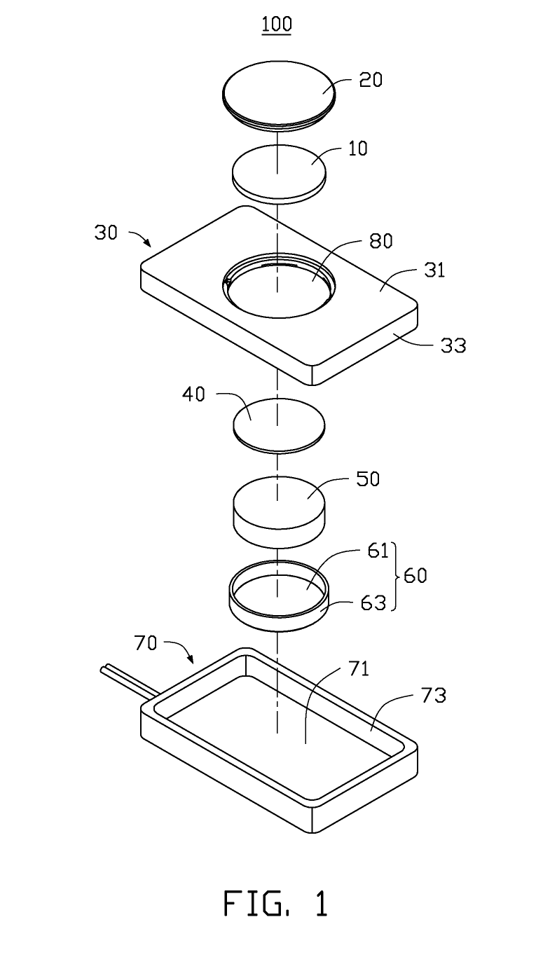

FIG. 1 illustrates an embodiment of a loudspeaker 100. The loudspeaker 100 comprises a voice coil 10, a protecting cover 20, a voice cavity top case 30, a washer 40, a magnet 50, a loudspeaker sleeve 60, and a voice cavity bottom case 70.

The voice coil 10 and the magnet 50 can be arranged such that the voice coil 10 can be placed in the magnetic field of the magnet 50. In use, current flows through the voice coil 10, which when placed in this magnetic field of the magnet 50, causes the voice coil 10 to move in response to an applied signal to generate sound.

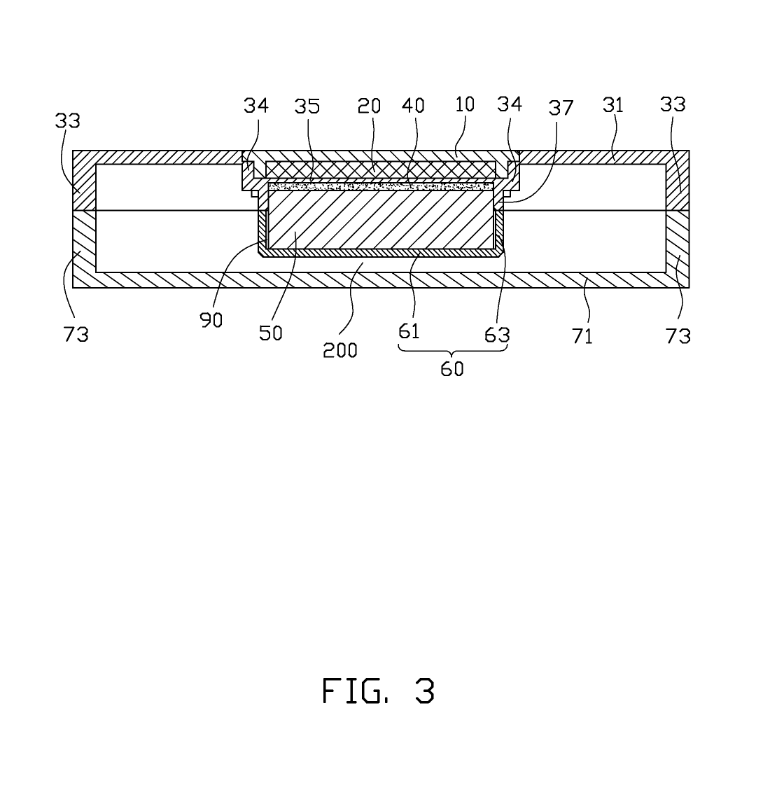

FIG. 3 illustrates the voice cavity top case 30 comprises a top panel 31, four side panels 33 extending from the top panel 31, a connecting portion 34 connected to the top panel 34, a resisting panel 35 connected to the connecting portion 34, and an extending portion 37. In at least one embodiment, each side panel 33 is substantially perpendicular to the top panel 31, and the resisting panel 35 is substantially parallel to the top panel 31. The connecting portion 34 is substantially L-shaped. The extending portion 37 extends from the connecting portion 34 and substantially perpendicular to the top panel 31 and the resisting panel 35. The connecting portion 34, the resisting panel 35, and the top panel 31 together defines a receiving space 80 that is used to receive the voice coil 10 and the protecting cover 20.

The washer 40 can be attached to the magnet 50. The loudspeaker sleeve 60 comprises a main base 61 and an extending wall 63 coupled to the main base 61. The main base 61 is substantially circle, and the extending wall 63 perpendicularly extends from edges of the circle defined by the main base 61. The extending wall 63 can be coupled with the extending portion 37, thereby an accommodating portion 90 is defined between the extending wall 63 and the extending portion 37 for receiving the washer 40 and magnet 50.

The voice cavity bottom case 70 comprises a bottom plate 71 and four side plates 73 coupled to four edges of the bottom plate 71. In at least one embodiment, each side plate 73 is substantially perpendicular to the bottom plate 71. The four side plates 73 can be secured to the four side panels 33, so that the voice cavity bottom case 70 is secured to the voice cavity top case 30.

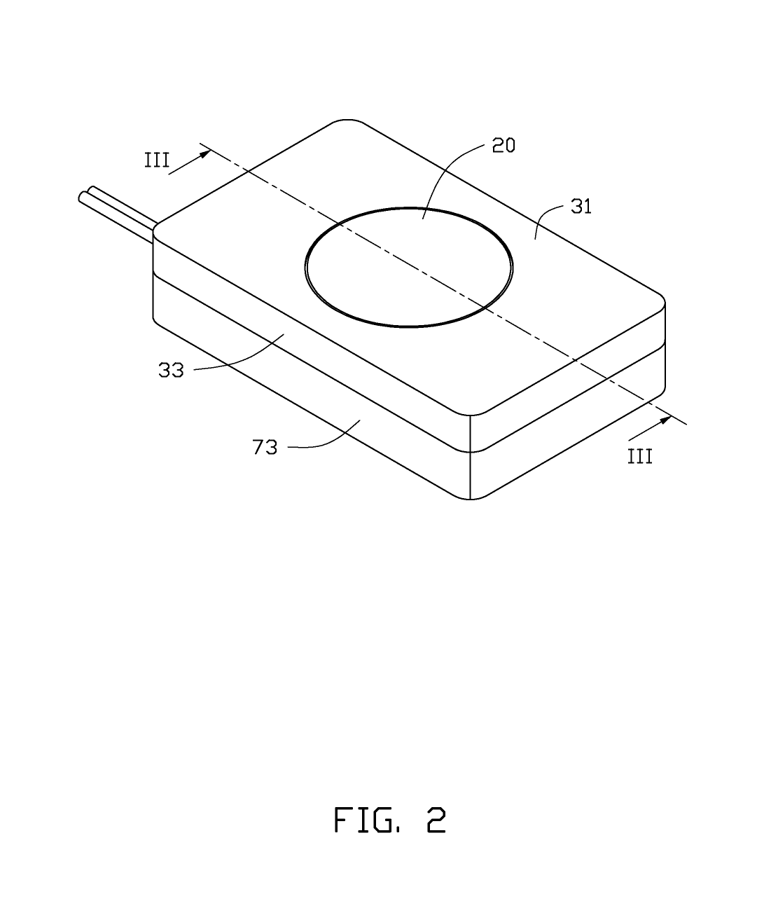

FIG. 2-3 illustrates in assembly, the protecting cover 20 is secured to the voice coil 10. The protecting cover 20 and the voice coil 10 are received in the receiving space 80, and the voice coil 10 is adhered to a top surface of the resisting panel 35. Thus, a top surface of the top panel 31 is aligned with a top surface of the protecting cover 20. The washer 40 is secured to the magnet 50, and the magnet 50 with the washer 40 is placed in the loudspeaker sleeve 60. The extending wall 63 is secured to the extending portion 37 by means, such as jointing. Therefore, the magnet 50 and the washer 40 can be received in the accommodating portion 90. The washer 40 is attached to a bottom surface of the resisting panel 35. In other words, the resisting panel 35 is sandwiched between the washer 40 and the voice coil 10. Each side plate 43 is secured to each side panel 33 to secure the voice cavity bottom case 70 to the voice cavity top case 30. At this time, a gap 200 is defined between the bottom plate 71 and the main base 61.

The resisting panel 35 is sandwiched between the washer 40 and the voice coil 10, and the top surface of the top panel 31 is aligned with the top surface of the protecting cover 20. The top panel 31 cannot be attached to the top surface of the protecting cover 20, so that the thickness of the loudspeaker 100 can be decreased.

The embodiments shown and described above are only examples. Many details are often found in the art such as the other features of a voice coil. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A loudspeaker comprising:
a voice coil;
a protecting cover attached to the voice coil;
a washer; and
a voice cavity top case comprising a top panel and a resisting panel coupled to the top panel;
wherein the revisiting panel is sandwiched between the washer and the voice coil, and
a top surface of the top panel is aligned with a top surface of the protecting cover.

2. The loudspeaker of claim 1, wherein the voice cavity top case further comprises a connecting portion coupled to the top panel and the resisting panel, and the connecting portion, the resisting panel and the top panel cooperatively define a receiving space which is configured to receive the voice coil and the protecting cover.

3. The loudspeaker of claim 2, wherein the connecting portion is substantially L-shaped.

4. The loudspeaker of claim 2, wherein the voice cavity top case further comprises an extending portion extending from the connecting portion, the loudspeaker further comprises a loudspeaker sleeve coupled with the extending portion.

5. The loudspeaker of claim 4, wherein the extending portion is substantially perpendicular to the top panel.

6. The loudspeaker of claim 4, further comprising a magnet attached to the washer, wherein an accommodating portion is defined between the extending portion and the loudspeaker sleeve and is configured to receive the magnet and the washer.

7. The loudspeaker of claim 4, further comprising a voice cavity bottom case, wherein the voice cavity bottom case comprises a bottom plate, and a gap is defined between the bottom plate and the loudspeaker sleeve.

8. The loudspeaker of claim 7, wherein the voice cavity bottom case further comprises four side plates coupled to the bottom plate, the voice cavity top case further comprises four side panels coupled to the bottom panel, and each side panel is coupled with each side plate.

9. A loudspeaker comprising:
a voice coil;
a protecting cover attached to the voice coil;
a washer; and
a voice cavity top case configured to receive the protecting cover, and the voice cavity top case is aligned with the protecting cover.

10. The loudspeaker of claim 9, wherein the voice cavity top case comprises a top panel and a resisting panel coupled to the top panel; the revisiting panel is sandwiched between the washer and the voice coil, and a top surface of the top panel is aligned with a top surface of the protecting cover.

11. The loudspeaker of claim 9, wherein the voice cavity top case further comprises a connecting portion coupled to the top panel and the resisting panel, and the connecting portion, the resisting panel and the top panel cooperatively define a receiving space which is configured to receive the voice coil and the protecting cover.

12. The loudspeaker of claim 11, wherein the connecting portion is substantially L-shaped.

13. The loudspeaker of claim 11, wherein the voice cavity top case further comprises an extending portion extending from the connecting portion, the loudspeaker further comprises a loudspeaker sleeve coupled with the extending portion.

14. The loudspeaker of claim 13, wherein the extending portion is substantially perpendicular to the top panel.

15. The loudspeaker of claim 13, further comprising a magnet attached to the washer, wherein an accommodating portion is defined between the extending portion and the loudspeaker sleeve and is configured to receive the magnet and the washer.

16. The loudspeaker of claim 13, further comprising a voice cavity bottom case, wherein the voice cavity bottom case comprises a bottom plate, and a gap is defined between the bottom plate and the loudspeaker sleeve.

17. The loudspeaker of claim 16, wherein the voice cavity bottom case further comprises four side plates coupled to the bottom plate, the voice cavity top case further comprises four side panels coupled to the bottom panel, and each side panel is coupled with each side plate.

18. A loudspeaker comprising:
a voice coil;
a protecting cover attached to the voice coil;
a washer; and
a voice cavity top case configured to receive the protecting cover, and the voice cavity top case and the protecting cover are coplanar.

19. The loudspeaker of claim 18, wherein the voice cavity top case comprises a top panel and a resisting panel coupled to the top panel; the revisiting panel is sandwiched between the washer and the voice coil, and a top surface of the top panel is aligned with a top surface of the protecting cover.
